(19) United States
(12) Patent Application Publication
(10) Pub. No.: US 2008/0184976 A1
(43) Pub. Date: Aug. 7, 2008

(54) Method of and Apparatus For Co-Fuelling Diesel Engines

(76) Inventors: Paul Gerard Joseph Johnston, Queensland (AU); Daniel Shane Egan, Queensland (AU)

Correspondence Address: ABELMAN, FRAYNE & SCHWAB, 666 THIRD AVENUE, 10TH FLOOR, NEW YORK, NY, 10017, US

(21) Appl. No.: 11/664,828

(22) PCT Filed: Oct. 3, 2005
(86) PCT No.: PCT/AU2005/001505

§ 371 Date: Oct. 30, 2007

(30) Foreign Application Priority Data
Oct. 4, 2004 (AU) 2004905677

(51) Int. Cl. F02B 13/00

(52) U.S. Cl. 123/575

(57) ABSTRACT

Apparatus for co-fuelling a diesel engine including a diesel engine having one or more combustion chambers; a co-fuel tank for containing a liquid co-fuel, the co-fuel tank being in fluid connection with the one or more combustion chambers; co-fuel delivery and delivery control means operatively interposed between the co-fuel tank and the one or more combustion chambers for delivering co-fuel from the co-fuel tank to the one or more combustion chambers; a liquid to gas converter operatively interposed between the co-fuel tank and the one or more combustions chambers for converting the liquid co-fuel from a liquid to a gas; and engine control means operatively associated with the diesel engine and the co-fuel delivery and delivery control means for controlling operation of the diesel engine and the delivery of the co-fuel to the one or more combustion chambers.

### FIELD OF INVENTION

THIS INVENTION relates to a method of and apparatus for co-fuelling diesel engines. The invention is primarily directed to co-fuelling of compression ignition, that is, diesel cycle, engines with fuels immiscible with the diesel fuel. However, the invention is not limited to this field of use.

### BACKGROUND ART

Recent developments in petrol or gasoline fuelled internal combustion engines have taken place with regard to the addition of alcohol, specifically ethyl alcohol (ethanol) to petrol or gasoline fuels for internal combustion engines. However, the introduction of alcohol as a fuel additive for diesel has been slow, mainly because alcohols generally, and lighter alcohols in particular, do not mix homogeneously with diesel fuel.

Arrangements for co-fuelling of diesel engines with gaseous fuels have been suggested. In such arrangements, gaseous fuel is sometimes injected into the intake manifold of the engine to supplement the diesel fuel, the two fuels being introduced into the combustion chamber, the diesel in the normal manner, and the gas being mixed with air prior to its introduction in the normal manner.

In this specification, unless the context indicates otherwise, all temperatures are expressed as temperatures at standard pressure. In this specification, unless the context requires otherwise, a reference to alcohol will be a reference to ethanol or mixtures which are substantially all ethanol.

The present invention aims to provide a method of and apparatus for co-fuelling diesel engines which enables the use of a liquid co-fuel for diesel engines. The invention also aims to provide a method of and apparatus for co-fuelling diesel engines which alleviates one or more of the disadvantages of the prior art. Other aims and advantages of the invention may become apparent from the following description.

### DISCLOSURE OF THE INVENTION

With the foregoing in view, this invention resides broadly in a method of co-fuelling a diesel engine, including:

vaporising a liquid fuel to provide a vaporised fuel;

introducing the vaporised fuel into a combustion chamber of the diesel engine together with air introduced thereto; and

introducing diesel fuel to the combustion chamber for combustion with the air and the vaporised fuel.

Preferably, the diesel fuel, vaporised fuel and air are introduced substantially simultaneously as in a typical diesel engine. More preferably, the liquid fuel is vaporised by the heat of the engine resulting from its normal operation. In such form, it is preferred that pre-heating means be provided for pre-heating the liquid fuel and vaporise it when the diesel engine is too cold. In such form, the pre-heating means is operable independently from the heat of the engine. In a preferred form, the method includes the vaporisation of ethanol.

In another aspect, the present invention resides broadly in a method of co-fuelling a diesel engine, including vaporising an alcoholic mixture to provide a vaporised alcoholic mixture;

introducing the vaporised alcoholic mixture into a combustion chamber of the diesel engine together with air introduced thereto; and

introducing diesel fuel to the combustion chamber for combustion with the air and the vaporised alcoholic mixture.

The alcoholic mixture is preferably includes alcohols and their close derivatives having a melting temperature below −10° C. and a boiling temperature above 35° C. Close derivatives comprise aldehyde and ketone derivatives selected for having similar melting and boiling properties to the alcohols falling within the selection. Preferably, the alcoholic mixture is substantially ethanol supplemented with one or more other members of the selection, such that the mixture has a melting temperature below −10° C. and a boiling temperature above 35° C. More preferably, the alcoholic mixture includes alcohols and their close derivatives having a boiling temperature above 64° C. In a further preferred form, the alcoholic mixture includes alcohols and their close derivatives having a boiling temperature above 78° C. In a preferred form, the alcoholic mixture is substantially ethanol.

It is also preferred that the alcoholic mixture is selected from materials which result in the production of substantially no toxic emissions. In particular, the alcoholic mixture is selected from materials which produce substantially no dioxins. In such form, it will be appreciated that the emissions produced would be those produced by the use of the alcoholic mixture in a diesel engine in accordance with the method of the present invention.

In another aspect, the present invention resides broadly in apparatus for co-fuelling a diesel engine including:

a diesel engine having one or more combustion chambers;

a co-fuel tank for containing a liquid co-fuel, the co-fuel tank being in fluid connection with the one or more combustion chambers;

co-fuel delivery and delivery control means operatively interposed between the co-fuel tank and the one or more combustion chambers for delivering co-fuel from the co-fuel tank to the one or more combustion chambers;

a liquid to gas converter operatively interposed between the co-fuel tank and the one or more combustions chambers for converting the liquid co-fuel from a liquid to a gas; and

engine control means operatively associated with the diesel engine and the co-fuel delivery and delivery control means for controlling operation of the diesel engine and the delivery of the co-fuel to the one or more combustion chambers.

In another aspect, the present invention resides broadly in apparatus for co-fuelling a diesel engine having one or more combustion chambers including:

a co-fuel tank for containing a liquid co-fuel, the co-fuel tank being in fluid connection with the one or more combustion chambers of the diesel engine;

co-fuel delivery and delivery control means operatively interposed between the co-fuel tank and the one or more combustion chambers for delivering co-fuel from the co-fuel tank to the one or more combustion chambers of the diesel engine;

a liquid to gas converter operatively interposed connected to the co-fuel tank for converting the liquid co-fuel from a liquid to a gas; and

a co-fuel control system operatively associated with the diesel engine for controlling the delivery of the co-fuel to the one or more combustion chambers.

Preferably, the co-fuel delivery and delivery control means includes a co-fuel pump. Preferably the co-fuel delivery and delivery control means includes one or more venturis and or one or more injectors. Preferably, the co-fuel delivery and delivery control means includes a flow control valve. Preferably the engine control means includes a co-fuel control system for controlling the delivery of the co-fuel to the diesel engine, the co-fuel control system being operatively associated with a diesel engine control system for controlling the operation for the diesel engine. In such form, it is preferred that the co-fuel control system be adapted as an add-on to an existing diesel engine such that the apparatus of the present invention may be provided in the form of an add-on co-fuelling system which may be added on to an existing diesel engine of the prior art.

The co-fuel control system preferably includes a plurality of sensors for sensing operational parameters of the diesel engine and/or the add-on co-fuelling system. Of course, where sensors are provided in conjunction with an existing diesel engine, parameters sensed by same for operation of the diesel engine may be operatively connected to the co-fuel control system. For example, the sensors may include sensors for sensing manifold absolute pressure (MAP), exhaust temperature, engine temperature, liquid-to-gas converter temperature and/or ambient air temperature. In such form, the sensors report the status of various transducers disposed at selected locations in respect of the engine. The sensors may also includes sensors for monitoring and/or reporting fuel economy, turbo boost, engine speed, air mass flow rate, inlet vacuum pressure, fuel flow rate and such like.

In a preferred form, liquid co-fuel from the co-fuel tank is pumped by an electrically driven co-fuel pump along a co-fuel line. Non-return valves are provided along the co-fuel line before and/or after the co-fuel pump. Preferably, the pumped liquid co-fuel passes through a converter solenoid lock prior to entering the liquid-to-gas converter. The liquid-to-gas converter is heated preferably by engine to a temperature high enough to substantially vaporise the co-fuel to a gas. For example, where the co-fuel in ethanol, the converter is heated by engine oil to a preferred temperature between 78.3° C. and 100° C. It will be appreciated that the operative temperature range is selected according to provide for vaporisation of the co-fuel prior to being mixed with air for aspiration or injection into the combustion chamber.

The vapour and/or vapour and liquid co-fuel preferably then to either one or more venturis or one or more injectors located in the intake manifold of the diesel engine. Preferably, the point at which the co-fuel is added to the intake manifold is two or more pipe diameters downstream from low-disturbing influences in the piping, such as bends and fittings. If a compressor for the engine air, such as a turbo charger or supercharger, is fitted, it is preferred that the air intake pipe be mounted to air the intake upstream thereof.

Flow control of the co-fuel is preferably achieved by way of a bullet valve driven by rated stepper motor having a device in operative association therewith for providing feedback control to the co-fuel controller of the condition of the valve.

It is preferred that the co-fuel control system be programmed to remain in a standby mode when the ignition system of the diesel engine is switched on, upon ignition, the control system receives a signal (“ignition signal”) from the engine's alternator or dynamo. Once the ignition signal is received, the co-fuel control system latches on and energises the converter's gas lock to release the liquid co-fuel. At the same time, the co-fuel pump is enabled. If required prior to the engine reaching operating temperature, the converter may be heated by an external means, such as an electric heater, to produce the required gas flow.

The ethanol liquid and/or vapour may be injected in pre-selected volume directly into the intake manifold of the engine. The apparatus of the present invention can also accommodate a combination of both vacuum assisted vapour fumigation and/or liquid injection. Either a MAP sensor (turbo charged diesel engine) or a mass air flow meter (naturally aspirated diesel engine) is fitted as part of the system in order to monitor engine workload. The MAP sensor reading may be used, preferably in conjunction with a diesel fuel flow transducer, to control the amount of ethanol vapour to be delivered to the engine's air intake so that a selected ratio of co-fuel to diesel fuel is maintained in proportion to changing engine operational parameters.

A vacuum manifold absolute pressure (VAP) sensor may be installed on the intake manifold to monitor inlet manifold vacuum pressure. The signal from the VAP sensor may be used to control the converter lock to shut off the co-fuel supply if the negative pressure exceeds predetermined limits.

The co-fuel control system is preferably programmed to record the intake pressure for a predetermined period after ignition, such as, for example, twenty hours. The recorded information may be then used to maintain the co-fuel delivery system within a derived operational band. In such form, it is preferred that a change in operational conditions such as to cause VAP to rise (more than a predetermined amount) causes the co-fuel delivery to shut down until it is manually reset. This feature is preferred in order to guard against over-fuelling with co-fuel caused by a vacuum pressure increase within the inlet manifold, such as may be caused, for example, by a blocked air filter.

The ambient air temperature sensor is preferably disposed in the air intake of the engine. A high temperature sensor is preferably disposed in the exhaust system of the engine to monitor exhaust temperature. Preferably, the high temperature sensor is disposed as close as practicable to the engine manifold. Another preferred inclusion in the programming of the co-fuel control system is to provide that upon receipt of sensor information indicating that the exhaust and/or turbo temperature exceeds the engine manufacturer's specifications, the delivery of co-fuel is reduced to compensate. More preferably, the co-fuel control system is programmed to decrease the co-fuel delivery progressively as the temperature passes predetermined increments above the manufacturer's specifications. Over-fuelling of diesel engines during moderate combustion pressures may generate low levels of combustion knock or detonation. Diesel knock may be detected by acoustic transducers. If detected, the high-cetane ethanol fuel delivery may be reduced proportionately to the amplitude and duration of the knock. The maximum allowable knock amplitude can be set, for example, from 10 to 100. If a preset threshold is achieved gas may be reduced by a preset level from, say, 0 to 255 steps for a preset duration of 0 to 100 seconds.

It is also preferred that a sensor (“lambda sensor” be disposed in the engine exhaust. As oxygen decreases, the lambda sensor output voltage will decrease. When such a decrease is detected by the co-fuel control system, the controller will decrease the co-fuel supply. Conversely, an increase in oxygen will result in a controlled increase in the co-fuel supply. More preferably, a set point for the lambda sensor voltage is provided to the co-fuel control system to define at which point the co-fuel will be decreased. In such form, the co-fuel reduction is proportionally up to a maximum setting.

In order to achieve a greater density of intake air, an ozone generator may be provided in operative connection with the air intake of the engine. A preferred capacity of the generator is sufficient to produce ozone from 0.8 to 1.2 g/m3. It is believed that the effect of ozone is similar to utilising an intercooler. In either case, more oxygen is available to support combustion of the fuels.

In typical fashion to existing systems, a catalytic oxidiser is included in the exhaust system. However, if the exhaust temperatures are below the operating temperature of the catalytic monolith, emissions will not be affected. In order to alleviate this problem in extremely clod conditions, an electric heater coil may be placed in operative disposition with respect to the exhaust system upstream of the catalytic oxidiser. Should the exhaust system temperature fall below the minimum operating temperature required for catalytic oxidation to occur, the electric heater coil may be powered under the control of either the engine controller or the co-fuel control system.

When a vehicle powered by a diesel engine having the apparatus of the invention is in “cruise mode”, the co-fuel control system preferably monitors the foot and engine brakes in order to permit the system to be placed in “idle mode” (foot brake) or cut out completely (engine brake) to enhance fuel efficiency by reducing the amount of co-fuel, and therefore, total fuel, usage of the engine having the apparatus for co-fuelling diesel engines of the present invention.

### BRIEF DESCRIPTION OF THE DRAWINGS

In order that the invention may be more readily understood and put into practical effect, reference will now be made to the accompanying drawings which illustrate preferred embodiments of the invention and wherein:

FIG. 1 is a schematic diagram of apparatus for co-fuelling a diesel engine according to the invention.

### DETAILED DESCRIPTION OF THE DRAWINGS

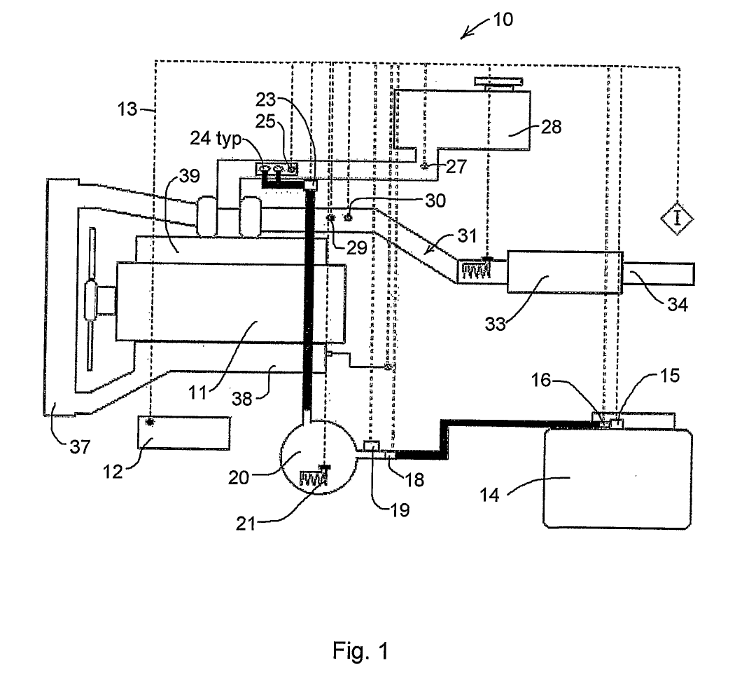

The diesel engine co-fuelling apparatus 10 shown in FIG. 1 incorporates a diesel engine 11 together with the normal elements associated with a diesel engine. Such elements include an inlet manifold 38 and an exhaust manifold 39. An engine management module 12 forms part of the co-fuelling apparatus and is in operative connection with other elements of the co-fuelling apparatus by way of an I/O cable 13.

An ethanol fuel tank 14 is provided for storing ethanol fuel as a co-fuel for supply to the diesel engine. The ethanol fuel tank includes a fuel pump 15 and a pressure sensor 16, each of which is in electrical connection with the engine management module by way of the I/O cable. The fuel pump is operable for pumping liquid ethanol from the ethanol fuel tank through an ethanol fuel line 17 which leads to a phase converter 20 through a non-return valve 18 and a converter lock 19. The non-return valve and converter lock are in electrical connection with the engine management module by way of the I/O cable. The phase converter has incorporated therein or associated therewith an ethanol heater 21, which is also in connection with the engine management module by way of the I/O cable. An ethanol vapour line 22 leads from the phase converter to an air intake 26 of the diesel engine. The ethanol vapour line feeds the air intake through a valve with stepper motor 23 leading in turn to plurality of injectors shown typically at 24. An air temperature sensor 25 is disposed in the air intake and is in electrical connection with the engine management module by way of the I/O cable. A VAP sensor is also disposed with the air intake downstream from an air cleaner 28. A MAP sensor 35 is also provided on the inlet manifold to the diesel engine after an intercooler 37.

An exhaust system for the diesel engine is shown generally at 31. A knock sensor 29 and oxygen sensor 30 are provided in the exhaust system upstream from an exhaust heater 32, the exhaust heater being disposed in the exhaust system for heating exhaust from the diesel engine if it is too cool for efficacy of catalytic conversion of contaminants in the exhaust. The knock sensor, oxygen sensor and exhaust heater are in electrical connection with the engine management module by way of the I/O cable. The exhaust heater is upstream from a catalytic converter 33 which is turn leads to a tail pipe 34.

An ignition sensor 36 is also in controlling with the engine management module by way of the I/O cable to sense the opening or closing of an ignition circuit to initiate operation of the engine management module.

The method of and apparatus for co-fuelling diesel engines of the present invention may be used in automotive applications where a diesel engine powers, for example, a road vehicle. The co-fuelling control system (engine management module) may be programmed to adjust ethanol or other co-fuel to accommodate different driving conditions and/or as a consequence of variations to engine loading, road conditions, seasonal or climactic changes or driver behaviour. The control system typically is arranged to monitor, for example, ambient temperature, common rout designations as may be provided from global positioning system devices or the like, anticipated seasonal changes according to a calendrical cycle programmed into the system or accessed remotely by the system. Driver behaviour may be monitored by receiving signals from, for example, one or more strain gauges operatively mounted to one or more engine mounts. A set of factory settings may be provided according to a predetermined “average” set of settings, permitting the co-fuelling control system to adjust co-fuel flow as conditions vary from the settings. A communications module is also preferably provided in operative association with the control system to enable remote monitoring and/or programming of parameters and the like from one or more command centres. Accordingly, an on-board or off-board emulator may be provided to receive signals from one or more of the sensors to permit de-rating or re-rating of the engine's horsepower to enable operation of the engine within the manufacturers' specifications.

It is believed that with the appropriate selection of the co-fuel, and particularly in the case of ethanol, the co-fuel behaves at least partly as a catalytic fuel.

Although the invention has been described with reference to one or more specific examples, it will be appreciated by persons skilled in the art that the invention may be embodied in other forms which are encompassed within the broad scope and ambit of the invention as claimed by the following claims.

1. A method of co-fuelling a diesel engine, including:
Vaporizing a liquid fuel to provide a vaporized fuel;
Controlling flow of the vaporized fuel in the vapour phase to provide a flow-controlled vaporized fuel;
Mixing the flow-controlled vaporized fuel with air to provide a vapour fumigated air; introducing the fumigated air into a combustion chamber of the diesel engine; and introducing diesel fuel to the combustion chamber for combustion with the air and the vaporized fuel.

2. The method according to claim 1, wherein the diesel fuel, flow-controlled vaporized fuel and air are introduced substantially simultaneously.

3. The method according to claim 1, wherein the liquid fuel is vaporized by the heat of the engine resulting from its normal operation.

4. A method of co-fueling a diesel engine, including vaporizing an alcoholic mixture to provide a vaporized alcoholic mixture;
controlling flow of the vaporized alcoholic mixture to provide a flow-controlled vaporized alcoholic mixture;
mixing the flow-controlled alcoholic mixture with air to provide a vapour fumigated air;
introducing the vapour fumigated air into a combustion chamber of the diesel engine; and
introducing diesel fuel to the combustion chamber for combustion with the air and the reported alcoholic mixture.

5. The method according to claim 4, wherein the alcoholic mixture is substantially ethanol supplemented with one or more other members of the selection such that the mixture has a melting temperature below −10° C. and a boiling temperature above 35° C.

6. A method according to claim 4, wherein the alcoholic mixture includes alcohols and their close derivatives having a boiling temperature above 64° C.

7. A method according to claim 4, wherein the alcoholic mixture includes alcohols and their close derivatives having a boiling temperature above 78° C.

8. The method according to claim 7, wherein the alcoholic mixture is substantially ethanol.

9. A method according to claim 4, wherein the alcoholic mixture is selected from materials which result in the production of substantially no toxic emissions following combustion.

10. The method according to claim 9, wherein the alcoholic mixture is selected from materials which produce substantially no dioxins following combustion.

11. Apparatus for co-fuelling a diesel engine including:
a diesel engine having one or more combustion chamber;
a co-fuel tank for containing a liquid on-fuel, the co-fuel tank being in fluid connection with the one or more combustion chambers:
co-fuel delivery and delivery control means operatively interposed between the co-fuel tank and the one or more combustion chambers for delivering co-fuel from the co-fuel tank to the one or more combustion chambers;
an air intake construction operatively associated with the one or more combustions chambers for receiving air thereunto
a liquid-to-gas converter operatively interposed between the co-fuel tank and the air intake construction nor converting the liquid co-fuel from a liquid to a gas; and
an engine control means operatively associated with the diesel engine and the co-fuel delivery and delivery control means for controlling operation of the diesel engine and the delivery of the co-fuel to the one or more combustion chambers;
wherein the co-fuel delivery control means is provided downstream from the liquid-to-gas converter such that the co-fuel delivery control means is operable to control the flow of co-fuel in a gaseous state to the air intake construction.

12. Apparatus for co-fueling a diesel engine having one or more combustion chambers including:
a co-fuel tank for containing a liquid co-fuel, the co-fuel tank being in fluid connection with the one or more combustion chambers of the diesel engine;
co-fuel delivery and delivery control means operatively interposed between the co-fuel tank and the one or more combustion chambers for delivering co-fuel from the co-fuel tank to the one or more combustion chambers of the diesel engine;
a liquid-to-gas converter operatively interposed connected to the co-fuel tank for converting the liquid co-fuel from a liquid to a gas;
an air intake construction operatively associated with the one or ore combustion chambers for receiving air thereunto; and
a co-fuel control system operatively associated with the diesel engine for controlling the delivery of the co-fuel in a gaseous state to the air intake construction for delivery to the one or more combustion chambers.

13. Apparatus according to claim 11, wherein the co-fuel delivery and delivery control means includes a co-fuel pump.

14. Apparatus according to claim 11, wherein the co-fuel delivery and delivery control means includes one or more venturies and or one or more injectors.

15. Apparatus according to claim 11, wherein the co-fuel delivery and delivery control means includes a flow control valve.

16. Apparatus according to claim 11, wherein the engine control means includes a co-fuel control system for controlling the delivery of the co-fuel to the diesel engine, the co-fuel control system being operatively associated with a diesel engine control system for controlling the operation for the diesel engine.
